(19) United States
(12) Patent Application Publication
(10) Pub. No.: US 2025/0040583 A1
(43) Pub. Date: Feb. 6, 2025

(54) ENCAPSULATED METAL COMPOUNDS AND COMESTIBLE USES THEREOF

(71) Applicant: Firmenich SA, Satigny (CH)

(72) Inventors: Jian ZHANG, Plainsboro, NJ (US); Jingyu FENG, Plainsboro, NJ (US); Huda JERRI, Plainsboro, NJ (US)

(73) Assignee: Firmenich SA, Satigny (CH)

(21) Appl. No.: 18/718,209

(22) PCT Filed: Dec. 19, 2022
(86) PCT No.: PCT/EP2022/086790

§ 371 Date: Jun. 10, 2024

Related U.S. Application Data
(60) Provisional application No. 63/291,934, filed on Dec. 20, 2021.

(30) Foreign Application Priority Data
Jan. 4, 2022 (EP) 22150186.9

(51) Int. Cl. A23L 33/16; A23J 3/22; A23L 33/115; A23P 10/35

(52) U.S. Cl. CPC A23L 33/16; A23J 3/227; A23L 33/115; A23P 10/35

(57) ABSTRACT

The present disclosure relates generally to the use of metal compounds, such as metal salts or metal complexes, and their use in food products and pet food products. In some embodiments, the metal compounds are encapsulated in an encapsulant designed to release the metal compounds upon heating, such as cooking. In certain aspects, the disclosure provides meat analogue products that include such encapsulated metal compounds.

### TECHNICAL FIELD

The present disclosure relates generally to the use of metal compounds, such as metal salts or metal complexes, and their use in food products and pet food products. In some embodiments, the metal compounds are encapsulated in an encapsulant designed to release the metal compounds upon heating, such as cooking. In certain aspects, the disclosure provides meat analogue products that include such encapsulated metal compounds.

### DESCRIPTION OF RELATED ART

The human diet generally contains a combination of animal-derived and non-animal-derived products. One of the most common animal-derived products consumer by humans is meat. Meat is often characterized according to color, such as red meat or white meat. In general, red meats tend to contain relatively higher concentrations of iron-containing proteins, such as myoglobin.

Red meats, such as beef and lamb, are commonly consumed by humans around the globe. Such meats have a savory taste that is enhanced by the presence of the iron-containing proteins in such meats. But in recent years, concerns have begun to develop in connection with the consumption of red meat. One such concern is a sustainability concern. Raising cattle, in particular, requires large amounts of grain or grass to use as feed. It requires many times more acres of land to grow the grass or grain to feed cattle than it would to grow plants for direct human consumption. Thus, as the population continues to increase, the demand for increasing agricultural space becomes steadily unsustainable. Moreover, red meats can be high in certain saturated fats and other compounds that increase the risk of cardiovascular disease. Eating elevated amounts of red meat has also been associated with increased risk of certain cancers.

Thus, there is increasing demand to replace red meat in the human diet with similar plant-derived materials. In many cases, because consumers have become accustomed to consuming red meat, these plant-based foods are designed to simulate the flavor, texture, and culinary experience of consuming red meat. Creating such meat analogue materials poses a number of challenges, as one attempts to use plant-derived materials to create a food product that reminds the consumer of the experience of eating meat. One such challenge involves simulating the taste imparted by the iron-based proteins in meat with plant-based alternatives. Legumes, such as peas, lentils, and soybeans, contain iron, but at much lower concentrations than in meats, such as beef or lamb. Thus, without supplementing meat analogue products with iron compounds, it can be challenging to match the flavor imparted by iron-containing compounds found in red meat.

But iron compounds can behave quite differently in meat analogue products than in meat products, such as ground beef. For example, the iron compounds used to enhance the flavor can interact with other ingredients of the meat analogue material to give the uncooked material an undesirable grayish brown color instead of the typical reddish color of uncooked red meat. Of course, for the iron compounds to impart flavor to the cooked product, they should be well dispersed throughout the matrix. Therefore, there is a continuing need to discover new ways of introducing metal compounds, such as iron compounds, into meat analogue products.

### SUMMARY

The present disclosure relates to the discovery of a means of encapsulating metal compounds so that they remain sequestered from the food matrix when the product is uncooked and subsequently disperse throughout the matrix when cooked.

In a first aspect, the disclosure provides a comestible particle, which comprises an encapsulant and an encapsulated material, and the encapsulated material is encapsulated by the encapsulant; wherein the encapsulant comprises a lipid component; and wherein the encapsulated material comprises a metal compound. In some embodiments, the particle has a peak melting temperature (Tₘ) of at least 30° C. In some embodiments, the metal compound is an iron compound, such as an iron salt or an iron complex. In some embodiments, the fat is a non-animal fat, such as a plant-derived fat.

In a second aspect, the disclosure provides a method of making a plurality of comestible particles of the first aspect, the method comprising: (a) forming a liquid composition comprising water, a lipid component, and a metal compound, wherein the lipid component and the metal compound are dispersed in the water; and (b) drying the liquid composition to form a plurality of comestible particles, wherein the plurality of comestible particles comprise an encapsulant and an encapsulated material, and the encapsulated material is encapsulated by the encapsulant; wherein the encapsulant comprises the lipid component and the encapsulated material comprises the metal compound.

In a third aspect, the disclosure provides a method of making a plurality of comestible particles of the first aspect, the method comprising: (a) forming a extrudable composition comprising a matrix material and a metal compound, wherein the metal compound is dispersed in the matrix compound; (b) extruding the extrudable composition to form a plurality of extruded particles; and (c) coating the extruded particles with a lipid coating, which comprises a lipid material to form the plurality of comestible particles, wherein the comestible particles comprise an encapsulant and an encapsulated material, and the encapsulated material is encapsulated by the encapsulant; wherein the encapsulant comprises the lipid component and the encapsulated material comprises the metal compound.

In a fourth aspect, the disclosure provides a plurality of comestible particles formed by the process of the second or third aspect.

In a fifth aspect, the disclosure provides uses of a plurality of comestible particles of the first aspect or the fourth aspect to modify a flavor, such as a beef-like flavor, of a comestible composition. In some embodiments, the comestible composition comprises a non-animal protein, such as a plant protein, for example, pea protein, hemp protein, or soy protein. In some embodiments, the comestible composition comprises one or more plant extracts, such as a beet extract, a cucumber extract, and the like. In some embodiments, the comestible composition comprises one or more fibers, such as plant fibers, for example, pea fiber, citrus fiber, and the like. In some embodiments, the comestible composition comprises a carrier. In some such embodiments, the carrier is an emulsion, such as a water-in-oil emulsion. In a related aspect, the disclosure provides corresponding methods of modifying a flavor, such as a beef-like flavor, of a comestible composition, the method comprising introducing a plurality of comestible particles of the first aspect or the fourth aspect to the comestible composition.

In a sixth aspect, the disclosure provides a comestible composition, which comprises a plurality of comestible particles of the first aspect or the fourth aspect. In some embodiments, the comestible composition comprises a non-animal protein, such as a plant protein, for example, pea protein, hemp protein, or soy protein. In some embodiments, the comestible composition comprises one or more plant extracts, such as a beet extract, a cucumber extract, and the like. In some embodiments, the comestible composition comprises one or more fibers, such as plant fibers, for example, pea fiber, citrus fiber, and the like. In some embodiments, the comestible composition comprises a carrier. In some such embodiments, the carrier is an emulsion, such as a water-in-oil emulsion.

In a seventh aspect, the disclosure provides uses of an organic acid, a chelating agent, or a combination thereof, to reduce discoloration of a comestible composition, wherein the comestible composition comprises an iron compound and a flavonoid. In certain related aspects, the disclosure provides methods of reducing discoloration in a comestible composition, the method comprising introducing an organic acid, a chelating agent, or any combination thereof, to the comestible composition, wherein the comestible composition comprises an iron compound and a flavonoid. In some embodiments, the comestible composition comprises a non-animal protein, such as a plant protein, for example, pea protein, hemp protein, or soy protein. In some embodiments, the comestible composition comprises one or more plant extracts, such as a beet extract, a cucumber extract, and the like. In some embodiments, the comestible composition comprises one or more fibers, such as plant fibers, for example, pea fiber, citrus fiber, and the like. In some embodiments, the comestible composition comprises a carrier. In some such embodiments, the carrier is an emulsion, such as a water-in-oil emulsion.

In an eighth aspect, the disclosure provides a comestible composition comprising: (a) an iron compound, (b) an organic acid, a chelating agent, or a combination thereof; and (c) one or more flavonoids. In some embodiments, the flavonoids are present in the comestible composition as part of certain natural extracts, such as beet root extract, apple extract, and the like. In some embodiments, the comestible composition comprises a non-animal protein, such as a plant protein, for example, pea protein, hemp protein, or soy protein. In some embodiments, the comestible composition comprises one or more plant extracts, such as a beet extract, a cucumber extract, and the like. In some embodiments, the comestible composition comprises one or more fibers, such as plant fibers, for example, pea fiber, citrus fiber, and the like. In some embodiments, the comestible composition comprises a carrier. In some such embodiments, the carrier is an emulsion, such as a water-in-oil emulsion.

In a ninth aspect, the disclosure provides a flavored product, which comprises the comestible composition of the sixth aspect or the eighth aspect. In some embodiments, the flavored product is a food product, such as a meat analogue product, for example, a non-animal-based ground beef replica. In some other embodiments, the flavored product is an animal feed product, such as pet food product. In such flavored products, the comestible composition can, in some embodiments, be used in combination with animal-based products to reduce the degree of animal fats or animal products in the comestible product. In other embodiments, the flavored products contain no animal-based products, such that the comestible composition is used to make an analogue or a replica of a meat product, such as a ground beef patty.

Further aspects, and embodiments thereof, are set forth below in the Detailed Description, the Abstract, and the Claims.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A is present and not B, that B is present and not A, or that A and B are both present. Further, if A, for example, defines a class that can have multiple members, e.g., A1 and A2, then one or more members of the class can be present concurrently.

Unless specified otherwise, numerical ranges expressed in the format “from x to y” are understood to include x and y. When for a specific feature multiple preferred ranges are described in the format “from x to y”, it is understood that all ranges combining the different endpoints are also contemplated.

All percentages refer to percent by weight unless stated otherwise.

The term “fat,” as used herein, refers to lipid components that are solid or in the form of a paste at 20° C., whereas the term “oil” used in the present disclosure refers to lipid components that are liquid at 20° C. The terms “fat” and “oil” are not limited to triglycerides, but also include monoglycerides, diglycerides, free fatty acids, and partially or fully hydrogenated derivatives of the foregoing.

The term “emulsion”, as used herein, denotes a mixture of two or more liquids that are normally immiscible (i.e. not mixable). In an emulsion, one liquid (the dispersed phase) is dispersed in the other (the continuous phase). In the present disclosure, it is described an oil-in water emulsions comprising a continuous hydrophilic phase comprising water, in which the hydrophobic phase is dispersed.

The melting profile can be measured by differential scanning calorimeter Q2000 (TA Instruments, New Castle, DE, USA). Typically, small samples (5˜10 mg) are sealed in hermetic aluminum pans (Tzero, T161003). Typically, the program consists of the following steps: equilibrate at −20° C. for 5 minutes, ramp to 100° C. at 10° C./min, cooling to −20° C., hold isothermal at −20° C. for 5 min and ramp to 100° C. at 10° C./min. The instrument was calibrated for the melting temperature and enthalpy of fusion of Indium (Standard Reference Material 2232, National Institute of Standards and Technology, Gaithersburg, MD). DSC is widely used to determine percent of fat melted at a certain temperature. This technique is based on measuring the heat of fusion successively at different temperatures. The melting peak temperature and enthalpy of fusion can be obtained using “integrate peak linear” for each DSC curve. The melting peak temperature is the peak temperature of the phase transition curve via DSC. By reference to the total melting heat, the fraction of fat melted is determined. The method is described in “Cassel RB. Determining percent solid in an edible fat. TA Instruments Applications Brief TA290. 2002”. The melting profile is taken from the first heating ramp (scan) of the DSC curve at 10° C./min. The percentage of the solid lipid melted as a function of temperature can be calculated using ‘running integral’. Tₘ represents melting peak temperature, Tso % represents the temperature at which 50% by weight of solid lipid melts, T95% represents the temperature at which 95% by weight of solid lipid melts.

In case of combination of more than two components, the melting profile of the mixture can be obtained by the same method as described previously.

By “melting temperature T_{50%}”, it is meant the temperature at which 50% by weight of plant-based fat melts.

By “melting temperature T_{95%}”, it is meant the temperature at which 95% by weight of plant-based fat melts.

Tₘ, T_{50%} and T_{95%} are well-known parameters used by the skilled person in the art. It can be easily determined by DSC (Differential Scanning calorimetry) as described above.

The term “plant-based fat” refers to a compound chosen from glycerides, fatty acids, hydrogenated oils that derived from plants.

By “flavor oil” it is meant here a flavoring ingredient or a mixture of flavoring ingredients.

By “perfume oil” it is meant here a perfuming ingredient or a mixture of perfuming ingredients.

“Emulsifiers” are amphiphilic molecules that concentrate at the interface between two phases and modify the properties of that interface. Examples of emulsifiers can be found in Mccutcheon's Emulsifiers & Detergents or the Industrial Surfactants Handbook.

Other terms are defined in other portions of this description, even though not included in this subsection.

### Comestible Particles

In certain aspects, the disclosure provides a comestible particle, which comprises an encapsulant and an encapsulated material, wherein the encapsulated material is encapsulated by the encapsulant; and wherein the encapsulant comprises a lipid component; and wherein the encapsulated material comprises a metal compound.

The comestible particles disclosed herein include an encapsulant, which encapsulates an encapsulated material. In some embodiments, the comestible particles are core-shell particles, where, for example, the encapsulant is the shell and the encapsulated material is the core. In some other embodiments, the comestible particle is a granule, where, for example, the encapsulant is a matrix and the encapsulated material is dispersed in the matrix. Other configurations are acceptable as well, so long as the encapsulant provides for the sequestration of the encapsulated material under certain conditions, such as certain temperature conditions or certain chemical environments, for a period of time.

As used herein, the term “particle” is not limited to particular shapes. For example, the particles can be in the shape of cones, spheres, cylinders, tubes, cubes, cuboids, prisms, pyramids, flakes, and the like. In some embodiments, the particles are flakes.

As noted above, the encapsulant comprises a lipid component. In general, the lipid component is a fatty acid glyceride (such as a monoglyceride, a diglyceride, or a triglyceride), a free fatty acid, a hydrogenated derivative of the foregoing, or any combination thereof. The lipid component can make up any suitable portion of the encapsulant. In some embodiments, for example, the lipid component makes up at least 20% by weight, or at least 30% by weight, or at least 40% by weight, or at least 50% by weight, or at least 60% by weight, or at least 70% by weight, or at least 80% by weight, or at least 90% by weight, or at least 95% by weight, of the encapsulant, based on the total dry weight of the encapsulant.

The lipid component can include any suitable lipid or combination of lipids. In some embodiments, the encapsulant comprises a fat, such as a non-animal fat. Any suitable non-animal fat can be used in the encapsulant, including fats derived from plants, fungi, algae, or any combinations thereof. In some embodiments, the non-animal fat is a plant-derived fat. In some embodiments, the non-animal fat comprises palm oil, palm kernel oil, coconut oil, cocoa butter, fractions of any of the foregoing, or any combinations thereof. As used herein, a “fraction” of a fat or an oil is a higher-melting portion of the fat or oil that is separated from other components in the fat or oil, for example, by crystallization. Palm stearin is a common example of such a fraction, which is obtained by the slow crystallization of palm oil and the separation of the higher-melting portion that crystallizes when heated palm oil is cooled to a temperature near its melting point. Other examples include shea stearin, rice stearin, and the like. Also, note that the term “oil” is used here with reference to these particular plant-based fate because that is the common term for referring to such fats, even though they are solids at 20° C. In some embodiments, the non-animal fat comprises palm oil or a fraction thereof, such as palm stearin. In some embodiments, the non-animal fat comprises coconut oil. In some embodiments, the non-animal fat comprises palm kernel oil. In some embodiments, the non-animal fat comprises cocoa butter. In general, the non-animal fat comprises mostly triglycerides. In some embodiments, some amount of monoglycerides and diglycerides can be present. For example, in some embodiments, the non-animal fat comprises at least 60% by weight, or at least 70% by weight, or at least 80% by weight, or at least 90% by weight, or at least 95% by weight, triglycerides, based on the total weight of glycerides in the encapsulant.

The non-animal fat can make up any suitable proportion of the encapsulant. For example, in some embodiments, the non-animal fat is present in the encapsulant at a concentration ranging from 30 percent by weight to 99 percent by weight, or from 50 percent by weight to 90 percent by weight, based on the total dry weight of the encapsulant.

In some embodiments, the encapsulant comprises a free fatty acid. In some such embodiments, the free fatty acids are derived from non-animal sources, such as plants, fungi, algae, or any combinations thereof. In some embodiments, the non-animal free fatty acids are derived from plants, such as palm, coconut, or cocoa. Non-limiting examples of free fatty acids suitable for use in the plurality of oleaginous particles include capric acid, lauric acid, myristic acid, palmitic acid, stearic acid, oleic acid, linoleic acid, linolenic acid, eicosapentaenoic acid, docosahexaenoic acid, or any combinations thereof. In some embodiments, the free fatty acid is palmitic acid. In some embodiments, the free fatty acid is stearic acid. In some embodiments, the free fatty acid comprises palmitic acid and stearic acid.

In embodiments where a non-animal free fatty acid and a non-animal fat are present in the encapsulant, the weight ratio of non-animal fat to non-animal free fatty acid ranges from 1:1 to 20:1, or from 2:1 to 15:1, or from 3:1 to 12:1. Or, in some other embodiments, where a non-animal free fatty acid and a non-animal fat are present in the encapsulant, the weight ratio of non-animal fat to non-animal free fatty acid ranges from 1:20 to 2:1, or from 1:10 to 1:1. The non-animal free fatty acids can make up any suitable proportion of the encapsulant. For example, in some embodiments, the non-animal free fatty acid is present in the encapsulant at a concentration ranging from 0.1 percent by weight to 30 percent by weight, or from 1 percent by weight to 20 percent by weight, based on the total dry weight of the encapsulant.

In some embodiments, the encapsulant comprise a carrier, for example, a solid carrier. This is often the case with extruded particles, where the encapsulated material is initially extruded in a carbohydrate-based matrix and then coated further with a lipid material. In certain embodiments, the comestible particles are prepared by methods such as spray drying or extrusion. In such cases, a solid carrier is present to facilitate the formation of the particles. Any suitable carrier material can be used, such as carrier materials commonly employed in the formation of comestible particles via spray drying or extrusion. In some embodiments, the solid carrier is water soluble. As used in this context, a carrier is “water soluble” if it forms a single-phase solution when dissolved in water at concentrations as high as 20 percent by weight. In some embodiments thereof, the water-soluble carrier forms a single-phase solution when dissolved in water at concentrations as high as 20 percent by weight, or as high as 40 percent by weight, or as high as 50 percent by weight. Some non-limiting examples of water-soluble carriers include: maltodextrin; inulin, or chicory fiber; plant-based proteins, such as pea protein; water-soluble flours; gums, such as gum Arabic; soluble fibers; soluble polysaccharides; and combinations thereof.

As used herein, the term “soluble fiber” refers to polysaccharides characterized as being soluble by using the method of the Association of Official Analytical Chemists (AOAC) and as set forth in Prosky et al., J. ASSOC. OFF. ANAL. CHEM., vol. 70 (5), pp. 1017-1023 (1988). Any suitable soluble fibers can be used, including, but not limited to, fruit fiber (such as citrus fiber), grain fibers, psyllium husk fiber, natural soluble fibers and synthetic soluble fibers. Natural fibers include soluble corn fiber, maltodextrin, acacia, and hydrolyzed guar gum. Synthetic soluble fibers include polydextrose, modified food starch, and the like. Non-limiting examples of food-grade sources of soluble fiber include inulin, corn fiber, barley fiber, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potatoes, konjac vegetable fiber (glucomannan), psyllium fiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose. In some embodiments, the carrier comprises maltodextrin, gum Arabic, pea protein, inulin, or any combination thereof. In some embodiments, the carrier comprises maltodextrin. In some embodiments, the carrier comprises a modified starch, such as dextrin. In some embodiments, the carrier comprises gum Arabic.

The carrier can be present in any suitable amount in the encapsulant. In some embodiments, the carrier makes up from 1 percent by weight to 50 percent by weight, or from 2 percent by weight to 30 percent by weight, or from 3 percent by weight to 20 percent by weight, of the encapsulant, based on the total dry weight of the encapsulant.

In some embodiments, the encapsulant comprises an emulsifier. As noted above, some carriers can serve simultaneously as an emulsifier, which can, among other things, assist in the process of forming the oleaginous particles by spray drying. In some embodiments, the emulsifier is a hydrophilic emulsifier, which, for example, can be suitable for spray drying an oil-in-water emulsion. Any suitable such emulsifier can be used. For example, polymeric emulsifiers and small molecule surfactants can be used. In some embodiments, the emulsifier is a plant-based protein, such as pea protein or rice protein, gum Arabic, modified food starch (for example, dextrin), Quillaja saponins, lecithin, or any combinations thereof.

The emulsifier can be present in any suitable amount in the encapsulant. In some embodiments, the carrier makes up from 1 percent by weight to 30 percent by weight, or from 2 percent by weight to 30 percent by weight, or from 5 percent by weight to 30 percent by weight, or from 8 percent by weight to 30 percent by weight, or from 8 percent by weight to 20 percent by weight, of the encapsulant, based on the total dry weight of the encapsulant.

The encapsulant can contain other ingredients, particularly various lipid-soluble ingredients. For example, in some embodiments, the encapsulant includes one or more flavor oils or lipid-soluble taste modifiers or taste compounds. For example, in some embodiments, the encapsulant comprises a flavoring oil, such as a beef flavor. In some embodiments, the flavoring oil comprises additional components that enhance or impart an umami taste, that enhance or impart a kokumi taste, or that mask or block a bitter taste.

The encapsulant can also contain certain materials that assist in the processing of the materials. For example, with extruded particles, the matrix material may include a lubricant to assist in the particle extrusion process. In these instances, any suitable lubricant can be used as are commonly used within the food processing industry.

Note that the encapsulant need not be homogeneous. In some cases, where the comestible particles are formed by a drying method, such as spray drying, the encapsulant will typically be reasonable homogeneous. But in some other cases, the encapsulant can have two or more distinct components. For example, if the comestible particles are prepared by extrusion, the particles may be first extruded using a carbohydrate, such as gum Arabic, where the encapsulated material is encapsulated within the matrix, where the extruded particles are subsequently coated with a fatty outer coating. In such a case, the encapsulant includes both the carbohydrate-containing matrix material and the fatty outer coating.

As noted above, the encapsulated material comprises one or more metal compounds, such as a metal salt or a metal complex. Such compounds can include any comestible metal salt or complex, such as salts or complexes of calcium, magnesium, sodium, potassium, iron, cobalt, copper, zinc, manganese, molybdenum, and selenium. In some embodiments, the iron compound is an iron salt or an iron complex. In some embodiments, the metal compound is a ferrous (Fe²⁺) salt or a ferrous (Fe²⁺) complex. In some embodiments, the metal compound is a ferrous (Fe²⁺) salt, such as ferrous sulfate, ferrous lactate, ferrous fumarate, ferrous gluconate, ferrous succinate, ferrous chloride, ferrous oxalate, ferrous nitrate, ferrous citrate, ferrous ascorbate, ferric citrate, ferric phosphate, or any combination thereof. In some other embodiments, the metal compound is a ferric (Fe³⁺) salt or a ferric (Fe³⁺) complex, such as ferric sulfate, ferric citrate, ferric chloride, ferric pyrophosphate, or any combinations thereof. In some embodiments, the iron compound is ferrous lactate, ferrous sulfate, ferrous citrate, or any combination thereof.

In some embodiments, the iron compound is a heme-containing protein. As used herein, the term “heme containing protein” includes any polypeptide covalently or noncovalently bound to a heme moiety. In some embodiments, the heme-containing polypeptide is a globin and can include a globin fold, which comprises a series of seven to nine alpha helices. Globin type proteins can be of any class (for example, class I, class II, or class III), and in some embodiments, can transport or store oxygen. For example, a heme-containing protein can be a non-symbiotic type of hemoglobin or a leghemoglobin. A heme-containing polypeptide can be a monomer, such as a single polypeptide chain, or can be a dimer, a trimer, tetramer, and/or higher order oligomer. The lifetime of the oxygenated Fe²⁺ state of a heme-containing protein can be similar to that of myoglobin or can exceed it by 10%, or 20%, or 30%>, or 40%, or 50%, or even 100%, or more under conditions in which the heme-protein-containing consumable is manufactured, stored, handled or prepared for consumption.

Non-limiting examples of heme-containing proteins include an androglobin, a cytoglobin, a globin E, a globin X, a globin Y, a hemoglobin, a myoglobin, an erythrocruorin, a beta hemoglobin, an alpha hemoglobin, a protoglobin, a cyanoglobin, a cytoglobin, a histoglobin, a neuroglobins, a chlorocruorin, a truncated hemoglobin (e.g., HbN or HbO), a truncated 2/2 globin, a hemoglobin 3 (e.g., Glb3), a cytochrome, or a peroxidase.

Heme-containing proteins that can be used in the comestible compositions described herein and can be from mammals (for example, farm animals such as cows, goats, sheep, pigs, ox, or rabbits), birds, plants, algae, fungi (for example, yeast or filamentous fungi), ciliates, or bacteria. For example, a heme-containing protein can be from a mammal such as a farm animal (e.g., a cow, goat, sheep, pig, fish, ox, or rabbit) or a bird such as a turkey or chicken. Heme-containing proteins can be from a plant such as Nicotiana tabacum or Nicotiana sylvestris (tobacco); Zea mays (corn), Arabidopsis thaliana, a legume such as Glycine max (soybean), Cicer arietinum (garbanzo or chick pea), Pisum sativum (pea) varieties such as garden peas or sugar snap peas, Phaseolus vulgaris varieties of common beans such as green beans, black beans, navy beans, northern beans, or pinto beans, Vigna unguiculata varieties (cow peas), Vigna radiata (mung beans), Lupinus albus (lupin), or Medicago sativa (alfalfa); Brassica napus (canola), Triticum sps. (wheat, including wheat berries, and spelt); Gossypium hirsutum (cotton); Oryza sativa (rice); Zizania sps. (wild rice); Helianthus annuus (sunflower); Beta vulgaris (sugarbeet); Pennisetum glaucum (pearl millet); Chenopodium sp. (quinoa); Sesamum sp. (sesame); Linum usitatissimum (flax); or Hordeum vulgare (barley). Heme-containing proteins can be isolated from fungi such as Saccharomyces cerevisiae, Pichia pastoris, Magnaporthe oryzae, Fusarium graminearum, Aspergillus oryzae, Trichoderma reesei, Myceliopthera thermophile, Kluyveramyces lactis, or Fusarium oxysporum. Heme-containing proteins can be isolated from bacteria such as Escherichia coli, Bacillus subtilis, Bacillus licheniformis, Bacillus megaterium, Synechocistis sp., Aquifex aeolicus, Methylacidiphilum infernorum, or thermophilic bacteria such as Thermophilus spp. The sequences and structure of numerous heme-containing proteins are known. See, for example, Reedy, et al, Nucleic Acids Research, 2008, Vol. 36, Database issue D307-D313 and the Heme Protein Database available on the world wide web at http://hemeprotein.info/heme.php.

In some embodiments, a non-symbiotic hemoglobin can be from any plant. In some embodiments, a non-symbiotic hemoglobin can be from a plant selected from the group consisting of soybean, sprouted soybean, alfalfa, golden flax, black bean, black eyed pea, northern bean, tobacco, pea, garbanzo, moong bean, cowpeas, pinto beans, pod peas, quinoa, sesame, sunflower, wheat berries, spelt, barley, wild rice, and rice.

In some embodiments, the heme-containing protein is a leghemoglobin, such as a soy, pea, or cowpea leghemoglobin.

In some embodiments, isolated plant proteins are used. As used herein, the term “isolated” with respect to a protein or a protein fraction (for example, a 7S fraction) indicates that the protein or protein fraction has been separated from other components of the source material (for example, other animal, plant, fungal, algal, or bacterial proteins), such that the protein or protein fraction is at least 2% (for example, at least 5%, or at least 10%, or at least 20%, or at least 25%, or at least 30%, or at least 35%, or at least 40%, or at least 45%, or at least 50%, or at least 55%, or at least 60%, or at least 65%, or at least 70%, or at least 75%, or at least 80%, or at least 85%, or at least 90%, or at least 95%, or at least 99%) free, by dry weight, of the other components of the source material. Thus, in some embodiments, the heme-containing protein (e.g., a plant heme-containing protein) is isolated. Proteins can be separated on the basis of their molecular weight, for example, by size exclusion chromatography, ultrafiltration through membranes, or density centrifugation. In some embodiments, the proteins can be separated based on their surface charge, for example, by isoelectric precipitation, anion exchange chromatography, or cation exchange chromatography. Proteins also can be separated on the basis of their solubility, for example, by ammonium sulfate precipitation, isoelectric precipitation, surfactants, detergents or solvent extraction. Proteins also can be separated by their affinity to another molecule, using, for example, hydrophobic interaction chromatography, reactive dyes, or hydroxyapatite. Affinity chromatography also can include using antibodies having specific binding affinity for the heme-containing protein, nickel nitroloacetic acid (NTA) for His-tagged recombinant proteins, lectins to bind to sugar moieties on a glycoprotein, or other molecules which specifically binds the protein.

In some embodiments, the isolated protein is decolorized. For example, the RuBisCO concentrates can be decolorized (pH 7-9) by passing over columns packed with activated carbon. The colorants can bind to the column while RuBisCO can be isolated in the filtrate. Alternatively, RuBisCO concentrates can be decolorized by incubating the solution with a FPX66 (Dow Chemicals) resin packed in a column or batch mode. The slurry is incubated for 30 minutes and then the liquid is separated from the resin. The colorants can bind to the resin and RuBisCO can be collected in the column flow-through. See also U.S. Patent Application Publication Nos. 2017/0298337, 2017/0321203, and 2017/0321204.

In some embodiments, a decolorized isolated plant protein can provide an increased shelf-life stability to the red color of the comestible composition as compared to a corresponding comestible composition including an isolated plant protein without decolorization. In some embodiments, the decolorized protein can lead to an improved flavor profile of the comestible composition as compared to that observed in a comestible composition with the corresponding isolated plant protein without decolorization.

Heme-containing or other proteins also can be recombinantly produced using polypeptide expression techniques (e.g., heterologous expression techniques using bacterial cells, insect cells, fungal cells such as yeast, plant cells such as tobacco, soybean, or Arabidopsis, or mammalian cells). For example, leghemoglobin can be recombinantly produced in E. coli or Pichia pastoris. In some cases, standard polypeptide synthesis techniques (such as liquid-phase polypeptide synthesis techniques or solid-phase polypeptide synthesis techniques) can be used to produce heme-containing proteins synthetically. In some cases, in vitro transcription-translation techniques can be used to produce heme-containing proteins.

The heme-containing proteins or iron salts can be used at any suitable concentration. Examples are set forth in PCT Publication No. WO 2015/153666, which is incorporated herein by reference.

The iron compound can make up any suitable weight of the comestible particle. In some embodiments, the iron compound makes up from 0.1 percent by weight to 50 percent by weight, or from 0.2 percent by weight to 20 percent by weight, or from 0.5 percent by weight to 10 percent by weight, of the comestible particle, based on the total weight of the comestible particle.

In some embodiments, the encapsulated material comprises an organic acid. Any suitable organic acid can be used, particularly organic acids commonly used in food and beverage products. Non-limiting examples include propionic acid, butyric acid, caproic acid, caprylic acid, succinic acid, cysteine (or hydrochloride salts thereof), proline (or hydrochloride salts thereof), lysine (or hydrochloride salts thereof), histidine (or hydrochloride salts thereof), methionine (or hydrochloride salts thereof), glutamic acid, aspartic acid, glutaric acid, thiamine (or hydrochloride salts thereof), pyrrolidone carboxylic acid, arachidonic acid, lactic acid, acetic acid, citric acid, ascorbic acid, oxalic acid, tartaric acid, malonic acid, malic acid, or any combinations thereof. In some embodiments, the organic acid is glutamic acid, cycteine hydrochloride, aspartic acid, proline, malic acid, citric acid, or any combinations thereof. In some embodiments, the organic acid is citric acid. In some embodiments, the organic acid is ascorbic acid. In some embodiments, the organic acid is succinic acid. In some embodiments, the organic acid is santalin A, santalin B, or any combination thereof (for example, from sandalwood extract).

The organic acid can be present in any suitable concentration in the comestible particle. In some embodiments, the organic acid makes up from 0.1 percent by weight to 50 percent by weight, or from 0.2 percent by weight to 20 percent by weight, or from 0.5 percent by weight to 10 percent by weight, of the comestible particle, based on the total weight of the comestible particle.

In some embodiments, the encapsulated material comprises one or more chelating agents. Any suitable chelating agent van be used, such as chelating agents commonly used in food and beverage products. Non-limiting examples of suitable chelating agents include: amino acids, such as glycine; amino carboxylates, such as ethylenediaminetetraacetic acid (EDTA) or salts thereof; hydroxy carboxylates, such as citric acid, gluconic acid, and tartaric acid; polyphosphates, such as hexametaphosphoric acid, pyrophosphoric acid, phytic acid, and tripolyphosphoric acid; cyclic acids, such as maltol or kojic acid; or any combinations thereof. In some embodiments, the chelating agent is maltol.

The chelating agents can be present in any suitable concentration in the comestible particle. In some embodiments, the chelating agent makes up from 0.1 percent by weight to 50 percent by weight, or from 0.2 percent by weight to 20 percent by weight, or from 0.5 percent by weight to 10 percent by weight, of the comestible particle, based on the total weight of the comestible particle.

The comestible particles further comprise one or more flavor oils, as mentioned above. The term “flavor oil” means a flavoring ingredient or a mixture of flavoring ingredients, solvents or adjuvants used or the preparation of a flavoring formulation, for example, a particular mixture of ingredients which is intended to be added to an edible composition (including but not limited to a beverage) or chewable product to impart, improve, or modify its organoleptic properties, in particular its flavor or taste. The flavor oil is a liquid at about 20° C. Flavoring ingredient is understood to include a variety of flavor materials of both natural and synthetic origins, including single compounds or mixtures. Many of these flavoring ingredients are listed in reference texts such as S. Arctander, PERFUME AND FLAVOUR CHEMICALS (1969), or its more recent versions, or in other works of similar nature such as FENAROLI'S HANDBOOK OF FLAVOUR INGREDIENTS (1975), or SYNTHETIC FOOD ADJUNCTS (1947). Solvents and adjuvants of current use for the preparation of a flavoring formulation are also well known in the industry. These substances are well known to the person skilled in the art of flavoring and/or aromatizing foods and consumer products.

The flavoring ingredient may be a taste modifier or a taste compound. Examples of taste compounds are salt, inorganic salts, organic acids, sugars, amino acids and their salts, ribonucleotides, and sources thereof.

A “taste modifier” is understood as an active ingredient that operates on a human taste receptors, or provides a sensory characteristic related to mouthfeel (such as body, roundness, or mouth-coating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

In some embodiments, the flavoring oil comprises a beef flavor. In some embodiments, the flavoring oil comprises additional components that enhance or impart an umami taste, that enhance or impart a kokumi taste, or that mask or block a bitter taste.

The comestible particles can have any suitable physical properties, such as melting properties. In many cases, it may be desirable to ensure that the particles remain reasonably intact physically at or around room temperature or colder. Thus, in some embodiments, the comestible particles have a peak melting temperature no greater than 25° C., or no greater than 30° C., or no greater than 35° C., or no greater than 40° C., or no greater than 45° C., or no greater than 50° C., or no greater than 55° C., or no greater than 60° C., or no greater than 65° C., or no greater than 70° C., or no greater than 75° C.

The comestible particles can have any suitable particle size. In some embodiments, the comestible particles have a minimum particle size of at least 10 μm, or at least 20 μm. In some embodiments, the comestible particles have an average particle size ranging from 50 μm to 5000 μm, or from 50 μm to 2000 μm, or from 50 μm to 1000 μm, or from 50 μm to 750 μm, or from 50 μm to 500 μm. In some embodiments, the comestible particles are in the form of a powder.

The particles can have any suitable pH. In some cases, where the particles are used in the context of meat analogues, it may be desirable for the particles to function to lower the pH of the matrix into which they are mixed. Thus, in some embodiments, the pH of the encapsulated material has a pH ranging from 2 to 7, or from 3 to 6.

The oleaginous particles can be formed by any suitable means, such as by spray drying or extrusion. Such methods are described in PCT Publication WO 2021/104846, which can be modified to suit the ingredients included herein.

### Methods of Making

In certain aspects, the disclosure provides a method of making the comestible particles described above. Any suitable method can be used to make particles incorporating encapsulation. Non-limiting examples include spray drying, melt extrusion, coacervation, granulation, freeze drying, drum drying, belt drying, tray drying, tunnel drying, extrusion, and the like.

In certain aspects, the comestible particles are made by a drying technique. Such drying techniques typically involve dispersing the components into a liquid carrier, for example, an aqueous medium, followed by a drying step that removes the solvent and leaves behind the comestible particles. For example, in some embodiments, the method comprises: (a) forming a liquid composition comprising an aqueous medium, a lipid component, and a metal compound, wherein the lipid component and the metal compound are dispersed in the aqueous medium; and (b) drying the liquid composition (for example, by removing the aqueous medium) to form a plurality of comestible particles. Such techniques are well known in the art, and can be adjusted for the ingredients used, for example, depending on the concentration of the metal compound, an organic acid, or a chelating agent.

In some other aspects, the comestible particles are made by an extrusion technique. Such extrusion techniques typically involve blending the components that make up the encapsulated material in a matrix material, such as gum Arabic, and extruding the resulting blend into particles, often with the aid of a lubricant. The particles are then coated via suitable means with a lipid-based coating. For example, in some embodiments, the disclosure provides a method of making a plurality of comestible particles of the first aspect, the method comprising: (a) forming a extrudable composition comprising a matrix material and a metal compound, wherein the metal compound is dispersed in the matrix compound; (b) extruding the extrudable composition to form a plurality of extruded particles; and (c) coating the extruded particles with a lipid coating, which comprises a lipid material to form the plurality of comestible particles, wherein the comestible particles comprise an encapsulant and an encapsulated material, and the encapsulated material is encapsulated by the encapsulant.

In some other aspects, the comestible particles are made by physically blending the encapsulated material (including a metal compound, and, optionally, an organic acid or a chelating agent) into a lipid material according to any of the embodiments set forth above. Once blended, the material is allowed to harden, and particles, for example, in the form of flakes, are formed by physically breaking up the solidified material.

In some embodiments, the particles are prepared by spray treating. In some such embodiments, the fatty composition is melted and the metal compounds (for example, iron salts) and any organic acids or chelating agents are mixed into the molten fatty mixture. The resulting mixture is then sprayed at low temperature such that small particles form with the resulting product being in the form of a powder.

Other suitable means of encapsulation can be used, according to the knowledge of those skilled in the art.

In certain aspects, the disclosure provides a plurality of comestible particles made by any of the aforementioned processes.

### Uses and Methods to Prevent Discoloration

In certain aspects, the disclosure provides surprising discoveries concerning the use of certain compounds to reduce the discoloration of comestible compositions containing iron compounds. Thus, in certain aspects, the disclosure provides uses of an organic acid, a chelating agent, or a combination thereof, to reduce discoloration of a comestible composition, wherein the comestible composition comprises an iron compound and a flavonoid. In certain related aspects, the disclosure provides methods of reducing discoloration in a comestible composition, the method comprising introducing an organic acid, a chelating agent, or any combination thereof, to the comestible composition, wherein the comestible composition comprises an iron compound and a flavonoid.

In some embodiments, the iron compound is an iron salt or an iron complex. In some embodiments, the metal compound is a ferrous (Fe²⁺) salt or a ferrous (Fe²⁺) complex. In some embodiments, the metal compound is a ferrous (Fe²⁺) salt, such as ferrous sulfate, ferrous lactate, ferrous fumarate, ferrous gluconate, ferrous succinate, ferrous chloride, ferrous oxalate, ferrous nitrate, ferrous citrate, ferrous ascorbate, ferric citrate, ferric phosphate, or any combination thereof. In some other embodiments, the metal compound is a ferric (Fe³⁺) salt or a ferric (Fe³⁺) complex, such as ferric sulfate, ferric citrate, ferric chloride, ferric pyrophosphate, or any combinations thereof. In some embodiments, the iron compound is ferrous lactate, ferrous sulfate, ferrous citrate, or any combination thereof.

The iron compound can make up any suitable weight of the comestible particle. In some embodiments, the iron compound makes up from 0.1 percent by weight to 50 percent by weight, or from 0.2 percent by weight to 20 percent by weight, or from 0.5 percent by weight to 10 percent by weight, of the comestible particle, based on the total weight of the comestible particle.

In some embodiments, the use comprises using an organic acid. Any suitable organic acid can be used, particularly organic acids commonly used in food and beverage products. Non-limiting examples include propionic acid, butyric acid, caproic acid, caprylic acid, succinic acid, cysteine (or hydrochloride salts thereof), proline (or hydrochloride salts thereof), lysine (or hydrochloride salts thereof), histidine (or hydrochloride salts thereof), methionine (or hydrochloride salts thereof), glutamic acid, aspartic acid, glutaric acid, thiamine (or hydrochloride salts thereof), pyrrolidone carboxylic acid, arachidonic acid, lactic acid, acetic acid, citric acid, ascorbic acid, oxalic acid, tartaric acid, malonic acid, malic acid, or any combinations thereof. In some embodiments, the organic acid is glutamic acid, cycteine hydrochloride, aspartic acid, proline, malic acid, citric acid, or any combinations thereof. In some embodiments, the organic acid is citric acid. In some embodiments, the organic acid is ascorbic acid. In some embodiments, the organic acid is succinic acid. In some embodiments, the organic acid is beta-santalic acid (for example, from sandalwood extract).

The organic acid can be used in any suitable concentration in the comestible particle. In some embodiments, the organic acid makes up from 0.1 percent by weight to 50 percent by weight, or from 0.2 percent by weight to 20 percent by weight, or from 0.5 percent by weight to 10 percent by weight, of the comestible particle, based on the total weight of the comestible particle.

In some embodiments, the use comprises using one or more chelating agents. Any suitable chelating agent van be used, such as chelating agents commonly used in food and beverage products. Non-limiting examples of suitable chelating agents include: amino acids, such as glycine; amino carboxylates, such as ethylenediaminetetraacetic acid (EDTA) or salts thereof; hydroxy carboxylates, such as citric acid, gluconic acid, and tartaric acid; polyphosphates, such as hexametaphosphoric acid, pyrophosphoric acid, phytic acid, and tripolyphosphoric acid; cyclic acids, such as maltol or kojic acid; or any combinations thereof. In some embodiments, the chelating agent is maltol.

The chelating agents can be used in any suitable concentration in the comestible particle. In some embodiments, the chelating agent makes up from 0.1 percent by weight to 50 percent by weight, or from 0.2 percent by weight to 20 percent by weight, or from 0.5 percent by weight to 10 percent by weight, of the comestible particle, based on the total weight of the comestible particle.

Further features and embodiments of the comestible composition are set forth in greater detail below in the section bearing that name.

### Uses and Methods for Flavor Modification

In certain aspects, the disclosure provides uses of a plurality of comestible particles according to any of the embodiments described above to modify a flavor, such as a beef-like flavor, of a comestible composition. As noted above, red meats often contain iron compounds that contribute to their characteristic flavor. Thus, the comestible particles that encapsulate iron compounds can be used to flavor or modify the flavor of various comestible compositions, such as meat analogue products, where such flavorings are desirable. In certain related aspects, the disclosure provides methods of modifying a flavor of a comestible composition, the method comprising introducing a plurality of comestible particles according to any of the embodiments described above to a comestible composition.

Further features and embodiments of the comestible composition are set forth in greater detail below in the section bearing that name.

### Comestible Compositions

In certain related aspects, the disclosure provides a comestible composition, which comprises a plurality of comestible particles according to any of the embodiments described above.

The comestible compositions can contain the comestible particles described above in any suitable concentration. For example, in some embodiments, the comestible composition comprises such comestible particles at a concentration such that the concentration of the metal compound (according to any of the embodiments set forth above) ranges from 0.001 percent by weight to 1.0 percent by weight, or from 0.005 percent by weight to 0.20 percent by weight, or from 0.01 percent by weight to 0.10 percent by weight, in the comestible composition, based on the total weight of the comestible composition.

In some embodiments, the comestible composition comprises one or more flavonoids, such as flavonoids from plant extracts, such as beet extract, apple extract, and the like.

The comestible composition can contain any of a number of ingredients, such as ingredients typically included in meat analogue products.

For example, in some embodiments, the comestible composition comprises a flavored water-in-oil emulsion according to any of the embodiments set forth in PCT Publication No. WO 2020/260628, which is hereby incorporated by reference.

In some embodiments, the comestible composition comprises encapsulated flavor compositions according to any of the embodiments set forth in PCT Publication No. WO 2021/104846, which is hereby incorporated by reference.

In addition to the soluble fibers mentioned above, the comestible composition can also include certain fibers, such as insoluble fibers, that can provide structure and texture to the comestible composition. Any suitable insoluble fiber can be used. In some embodiments, the insoluble fiber is a plant-derived fiber. Non-limiting examples include nut fibers, grain fibers, rice fibers, seed fibers, oat fibers, pea fibers, potato fibers, berry fibers, soybean fibers, banana fibers, citrus fibers, apple fibers, and carrot fibers. In some embodiments, the insoluble fiber is pea fiber. The insoluble fiber can make up any suitable proportion of the comestible composition. For example, in some embodiments, the soluble fiber makes up from 5 percent by weight to 50 percent by weight, or from 5 percent by weight to 40 percent by weight, or from 5 percent by weight to 30 percent by weight, or from 5 percent by weight to 20 percent by weight, of the comestible composition, based on the total weight of the comestible composition.

In certain aspects, the comestible composition comprises a non-animal protein, such as a plant protein, an algal protein, or a mycoprotein. In some embodiments, the comestible composition comprises a plant-based protein. Non-limiting examples of plant proteins include pea protein, soy protein, almond protein, cashew protein, canola (rapeseed) protein, chickpea protein, fava protein, sunflower protein, wheat protein, oat protein, and potato protein. The non-animal proteins can make up any suitable proportion of the comestible composition. For example, in some embodiments, the non-animal protein makes up from 5 percent by weight to 50 percent by weight, or from 5 percent by weight to 40 percent by weight, or from 5 percent by weight to 30 percent by weight, or from 5 percent by weight to 20 percent by weight, of the comestible composition, based on the total weight of the comestible composition.

In some embodiments, the comestible composition comprises one or more natural extracts to provide color, flavor, and the like. In some embodiments, the comestible composition comprises beetroot extract. The beetroot extract can be used to provide a red color characteristic of uncooked red meat products.

In some embodiments, the comestible compositions disclosed herein comprise a flavoring. In general, the flavoring improves the taste and flavor of the comestible composition or the resulting flavored product in which the comestible composition is used. Such improvement includes reducing the bitterness of the comestible composition or the resulting flavored product, reducing the perception of astringency of the comestible composition or the resulting flavored product, reducing the perception of green taste notes (such as pea taste) of the comestible composition or the resulting flavored product, reducing the perception of cereal notes of the comestible composition or the resulting flavored product, improving the perception of creaminess of the comestible composition or the resulting flavored product, improving the perception of creaminess of the comestible composition or the resulting flavored product, improving the perception of fattiness of the comestible composition or the resulting flavored product, improving the perception of sweetness of the comestible composition or the resulting flavored product, improving the perception of savory taste (umami or kokumi) of the comestible composition or the resulting flavored product, improving the mouthfeel or mouthcoating of the comestible composition or the resulting flavored product, improving the perception of juiciness of the comestible composition or the resulting flavored product, improving the perception of thickness of the comestible composition or the resulting flavored product, improving the vanillic character of the comestible composition or the resulting flavored product, or any combination thereof.

Any suitable flavoring can be used. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of other flavors include natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish crème, white chocolate, raspberry, pumpkin pie spice, peppermint, or any combination thereof.

In some embodiments, the flavoring is a meat flavoring, or other flavorings commonly used in the context of savory products. Such flavorings include glutamates, arginates, avocadene, avocadyne, a purine ribonucleitide (such as inosine monophosphate (IMP), guanosine monophosphate (GMP), hypoxanthine, inosine), a yeast extract, a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, or any combinations thereof.

In some embodiments, the flavoring comprises a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to 10 nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

The flavoring also includes, in certain embodiments, one or more additional flavor-modifying compounds, such as compounds that enhance sweetness (e.g., phloretin, naringenin, glucosylated steviol glycosides, etc.), compounds that block bitterness, compounds that enhance umami, compounds that enhance kokumi, compounds that reduce sourness or licorice taste, compounds that enhance saltiness, compounds that enhance a cooling effect, compounds that enhance mouthfeel, or any combinations of the foregoing.

Thus, in some embodiments, the flavoring comprises one or more sweetness enhancing compounds. Such sweetness enhancing compounds include, but are not limited to, naturally derived compounds, such as hesperitin dihydrochalcone, hesperitin dihydrochalcone-4′-O′glucoside, neohesperitin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1,6 bond, a β-1,2 bond, a β-1,4 bond, a β-1,6 bond, and so forth. In some embodiments of any of the preceding embodiments, the comestible composition comprises 3-((4-amino-2,2-dioxo-1H-benzo[c][1,2,6]thiadiazin-5-yl)oxy)-2,2-dimethyl-N-propyl-propanamide or N-(1-((4-amino-2,2-dioxo-1H-benzo[c][1,2,6]thiadiazin-5-yl)oxy)-2-methyl-propan-2-yl)isonicotinamide.

In some further embodiments, the flavoring comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl) decane-3,5-diol diacetate. In some embodiments, the umami-enhancing compound is N-(heptan-4-yl)benzo[d][1,3]dioxole-5-carboxamide.

In some further embodiments, the flavoring comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, the flavoring comprises one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

In some further embodiments, the flavoring comprises one or more sour taste modulating compounds.

In some further embodiments, the flavoring comprises one or more mouthfeel modifying compounds. Such mouthfeel modifying compounds include, but are not limited to, tannins, cellulosic materials, bamboo powder, and the like.

In some further embodiments, the flavoring comprises one or more flavor masking compounds. Such flavor masking compounds include, but are not limited to, cellulosic materials, materials extracted from fungus, materials extracted from plants, citric acid, carbonic acid (or carbonates), and the like.

In some embodiments, the flavor-modifying compounds described above are included to improve other tastants that may be present in the comestible composition itself, or that may be included within the flavored products that employ such compositions. Such tastants include sweeteners, umami tastants, kokumi tastants, bitter tastants, sour tastants, and the like.

For example, in some embodiments, the comestible composition or the resulting flavored product comprises a sweetener. The sweetener can be present in any suitable concentration, depending on factors such as the sweetener's potency as a sweetener, its solubility, and the like.

For example, in some embodiments, the sweetener is present in an amount from 0.1 weight percent to 12 weight percent. In some embodiments, the sweetener is present in an amount from 0.2% to 10% by weight. In some embodiments, the sweetener is present in an amount from 0.3% to 8% by weight. In some embodiments, the sweetener is present in an amount from 0.4% to 6% by weight. In some embodiments, the sweetener is present in an amount from 0.5% to 5% by weight. In some embodiments, the sweetener is present in an amount from 1% to 2% by weight. In some embodiments, the sweetener is present in an amount from 0.1% to 5% by weight. In some embodiments, the sweetener is present in an amount from 0.1% to 4% by weight. In some embodiments, the sweetener is present in an amount from 0.1% to 3% by weight. In some embodiments, the sweetener is present in an amount from 0.1% to 2% by weight. In some embodiments, the sweetener is present in an amount from 0.1% to 1% by weight. In some embodiments, the sweetener is present in an amount from 0.1% to 0.5% by weight. In some embodiments, the sweetener is present in an amount from 0.5% to 10% by weight. In some embodiments, the sweetener is present in an amount from 2% to 8% by weight. In some further embodiments of the embodiments set forth in this paragraph, the additional sweetener is sucrose, fructose (such as high-fructose corn syrup, fruit juice, and the like), glucose, xylitol, erythritol, glucose, allulose, or any combinations thereof. In some embodiments, the sweetener is sucrose.

In some other embodiments, the sweetener is present in an amount ranging from 10 ppm to 1000 ppm. In some embodiments, the sweetener is present in an amount from 20 ppm to 800 ppm. In some embodiments, the sweetener is present in an amount from 30 ppm to 600 ppm. In some embodiments, the sweetener is present in an amount from 40 ppm to 500 ppm. In some embodiments, the sweetener is present in an amount from 50 ppm to 400 ppm. In some embodiments, the sweetener is present in an amount from 50 ppm to 300 ppm. In some embodiments, the sweetener is present in an amount from 50 ppm to 200 ppm. In some embodiments, the sweetener is present in an amount from 50 ppm to 150 ppm. In some further embodiments of the embodiments set forth in this paragraph, the additional sweetener is a steviol glycoside (such as rebaudioside A, rebaudioside D, rebaudioside E, rebaudioside M, or any combination thereof), a mogroside (such as mogroside III, mogroside IV, mogroside V, siamenoside I, isomogroside V, mogroside IV_{E}, isomogroside IV, mogroside III_{E}, 11-oxomogroside V, the 1,6-α isomer of siamenoside I, and any combinations thereof), a derivative of either of the foregoing, such as glycoside derivatives (e.g., glucosylates), cyclamate, aspartame, sucralose, acesulfame K, or any combination thereof.

In general, the comestible compositions can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the additional sweetener is a combination of two or more of the sweeteners set forth in this paragraph. In some embodiments, the sweetener may combinations of two, three, four or five sweeteners as disclosed herein. In some embodiments, the additional sweetener is a sugar. In some embodiments, the additional sweetener is a combination of one or more sugars and other natural and artificial sweeteners. In some embodiments, the additional sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar is sucrose. In some embodiments, the sugar is a combination of fructose and glucose.

In some embodiments, the sweeteners can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green Stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet Stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

Additional sweeteners also include combinations of any two or more of any of the aforementioned sweeteners. In some embodiments, the sweetener may comprise combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a caloric sweetener, such as sucrose, fructose, xylitol, erythritol, or combinations thereof. In some embodiments, the comestible compositions are free (or, in some embodiments) substantially free of Stevia-derived sweeteners, such as steviol glycosides, glucosylated steviol glycosides, or rebaudiosides. For example, in some embodiments, the comestible compositions are either free of Stevia-derived sweeteners or comprise Stevia-derived sweeteners in a concentration of no more than 1000 ppm, or no more than 500 ppm, or no more than 200 ppm, or no more than 100 ppm, or no more than 50 ppm, or no more than 20 ppm, or no more than 10 ppm, or no more than 5 ppm, or no more than 3 ppm, or no more than 1 ppm.

In some embodiments, the comestible composition comprises an emulsifier, such as a non-hydrocolloid emulsifier. Any suitable non-hydrocolloid emulsifier can be used. For example, in some non-limiting embodiments, the emulsifier comprises lecithin, monoglycerides, diglycerides, polysorbates, vegetable oils, and the like. In some embodiments, the emulsifier comprises lecithin. The emulsifier can be present in any suitable concentration, which can be adjusted so as to form a stable emulsion of the other components in the comestible composition, for example, when incorporated into a flavored product.

In some instances, it may be desirable to include additives that assist in adjusting the viscosity of the comestible composition. Various salts and acids can be used to carry out such adjustments. In some embodiments, the comestible composition or the resulting flavored product comprises one or more salts. Non-limiting examples of suitable salts include magnesium sulfate, sodium chloride, sodium sulfate, calcium chloride, calcium sulfate, potassium sulfate, potassium chloride, potassium sorbate, potassium phosphate, potassium monophosphate, zinc chloride, zinc sulfate, or any mixtures thereof. In some embodiments, the comestible composition or the resulting flavored product also comprises one or more acids, which may be used alone or in combination with the aforementioned salts. Non-limiting examples of suitable acids include citric acid, lactic acid, acetic acid, tartaric acid, succinic acid, ascorbic acid, maleic acid, phosphoric acid, monopotassium phosphate, gluconic acid, glucono-lactone, glucoronic acid, glycyrrhetic acid, folic acid, pantothenic acid or mixtures thereof.

The comestible compositions disclosed herein can, in certain embodiments, contain other additives, adjuvants, and the like, that are commonly included in food products, pet food products, and feed products. For example, the comestible compositions disclosed herein can, in certain embodiments, comprise any additional ingredients or combination of ingredients as are commonly used in comestible products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

### Flavored Products

In certain aspects, the disclosure provides a flavored product, which comprises the comestible composition according to any of the embodiments set forth above. In some embodiments, the flavored product is a food product, such as a meat analogue product, for example, a non-animal-based ground beef replica. In some other embodiments, the flavored product is an animal feed product, such as pet food product. In such flavored products, the comestible composition can, in some embodiments, be used in combination with animal-based products to reduce the degree of animal fats or animal products in the comestible product. In other embodiments, the flavored products contain no animal-based products, such that the comestible composition is used to make an analogue or a replica of a meat product, such as a ground beef patty.

In some other embodiments, the flavored product is a meat-replacement product (or meat analogue), such as a product designed to mimic products traditionally made from red meat. For example, the flavored product can be a meat dough, such as those described in PCT Publication No. WO 2015/153666. Such flavored products can be designed to simulate beef products, such as ground beef (for making burgers) or cuts of beef for inclusion in soups, prepared meals, and the like. The flavored products can also be designed to simulate cuts or ground forms of other red meat, such as pork, goat, lamb, venison, and bison.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described, and claimed herein. The reader will recognize that the skilled artisan, armed with the present disclosure, and skill in the art is able to prepare and use the invention without exhaustive examples.

### Example 1: Preparation of Vegan Patties Containing Ferrous Lactate

Table 1 on the following page shows the formulation of vegan patties containing red beet color.

TABLE 1

| | Percentage (wt) |
|---|---|
| Water | 59.9 |
| Pea Protein¹ | 20 |
| Pea Protein² | 1.5 |
| Coconut Oil | 10 |
| Canola Oil | 5.0 |
| Methylcellulose | 2.0 |
| Salt (NaCl) | 0.8 |
| Lactic Acid | 0.3 |
| Red Beet Color³ | 0.3 |
| Brown Color⁴ | 0.1 |
| Red Color⁵ | 0.1 |

¹The pea protein is Nutralys T70S (Roquette)
²The pea protein is Nutralys F85M (Roquette)
³FruitMax Redbeet Red WSP (Oterra)
⁴FruitMax Brown 700 WSP (Oterra)
⁵FruitMax Red 101 WSP (Oterra)

The vegan patties are made by mixing all ingredients together with a mixer with a paddle attachment for about 2 minutes. Patties are then formed by taking about 100 grams of the mixed material and flattening the material to have a patty-like shape. The patties are then subjected to individual quick freezing (IQF) for 30 minutes and are store in a freezer.

Vegan patties containing beetroot red color stored in the freezer were thawed in the refrigerator for overnight. Then 0.03% ferrous lactate (Dr. Paul Lohmann GmbH KG, Germany) was added to the patty and mixed manually for 1 min. The patty was pressed to have patty-like shape, placed in the freezer for 1 day, and then transferred to a refrigerator for storage.

Discoloration from red to greenish-brown was observed immediately after mixing ferrous lactate in the patty base. After 1 day of storage in a freezer followed by 1 day storage in a refrigerator, the undesirable greenish-brown discoloration increased.

### Example 2: Preparation of Vegan Patties Containing Microencapsulated Ferrous Sulfate

Vegan patties (described above) containing beetroot red color stored in the freezer were thawed in the refrigerator for overnight. Then microencapsulated ferrous sulfate was added to the patty at a dosage of 0.03% ferrous sulfate and mixed manually for 1 min. The patty was pressed to have patty-like shape, placed in the freezer for 1 day, and then transferred to a refrigerator for storage.

The microencapsulated ferrous sulfate contains 50% palm fat coating prepared by molten fat spray coating process. No notable discoloration from red to greenish-brown was observed immediately after mixing microencapsulated ferrous sulfate with the base. However, a few greenish-brown spots were observed after 1 day freezing storage followed by 1 day refrigeration storage. It is expected that more dark spots will show up if it is stored in a refrigerator for a longer time, e.g., 1 week. Therefore, simple fat coating may not be adequate to prevent the iron from leaking into the base and thus reacting with beetroot color.

### Example 3: Preparation of Lipid Coated Microencapsulated Ferrous Sulfate Containing Citric Acid

Microencapsulated ferrous sulfate was further coated with a mixture of vegetable fat and fine citric acid to increase its moisture barrier property. The composition is shown in Table 2. A lipid blend of coconut oil and stearic acid was fully melted under heat, then fine citric acid was added and mixed uniformly in the molten lipid blend. The mixture was cooled to about 40-45° C. and then microencapsulated ferrous sulfate was added to the molten mixture and mixed uniformly. This molten mixture was poured into aluminum foil lined pan which was place in refrigerator for solidification. After fully solidified, the lipid mixture was grinded into smaller flakes. This flaked sample was added to vegan patty at a dosage of 0.03% ferrous sulfate.

TABLE 2

| Material | Weight percentage (%) |
|---|---|
| Microencapsulated ferrous sulfate | 5 |
| Coconut oil | 75 |
| Stearic acid | 10 |
| Citric acid | 10 |

No notable greenish-brown dark spots were observed during mixing and after 1 day freezing storage followed by 1 day refrigeration storage.

Interaction between metal ions and beetroot red is pH dependent. At lower pH (e.g., <6.0), iron addition does not change patty color significantly. The pH measurement showed that the bulk patty had pH of 6.2 whereas the pH around the lipid flake was about 5.9. Thus, incorporating acid in the lipid mixture can help modulate local pH which may suppress undesirable discoloration.

### Example 4: Preparation of Lipid Coated Microencapsulated Ferrous Sulfate Containing Ascorbic Acid

Microencapsulated ferrous sulfate (Dr. Paul Lohmann GmbH KG, Germany) was further coated with a mixture of vegetable fat and ascorbic acid to increase its moisture barrier property. The composition is shown in Table 3. A lipid blend of coconut oil and stearic acid was fully melted under heat, then ascorbic acid was added and mixed uniformly in the molten lipid blend. The mixture was cooled to about 40-45° C. and then microencapsulated ferrous sulfate was added to the molten mixture and mixed uniformly. This molten mixture was poured into aluminum foil lined pan and was stored in refrigerator for solidification. After fully solidified, the lipid mixture was grinded into smaller flakes. This flaked was added to vegan patty at a dosage of 0.03% ferrous sulfate.

TABLE 3

| Material | Weight percentage (%) |
|---|---|
| Microencapsulated ferrous sulfate | 5 |
| Coconut oil | 82 |
| Stearic acid | 12 |
| Ascorbic acid | 1 |

No dark greenish-brown spots were observed during mixing and preparation of patty. However, slight darkening was observed near the fat flakes after 1 day freezing storage followed by 1 day refrigeration storage.

### Example 5: Preparation of Fat Coated Extruded Ferrous Lactate Containing Ascorbic Acid

A BC-21 co-rotating twin-screw extruder (Clextral, Firminy France, L/D=32) was used to encapsulate ferrous lactate into a solid particulate form. The formula is shown in Table 4. Powder ingredients were pre-blended and then fed into the extruder by means of a loss-in-weight feeder with a flow rate of 8.0-9.0 kg/hr. A small amount of lubricant and water were injected into the extruder to obtain extruded particles with glass transition temperature (Tg) of around 40° C. Temperature set points of the extruder barrels ranged from 20-100° C. The screw speed kept constant at 500 rpm. The carbohydrate melt was extruded through a die plate with 0.7 mm diameter holes. After establishing steady-state extrusion condition, particles were cut by means of rotating cutting blades/knives and particles were sieved between 400 and 1,000 μm.

TABLE 4

| | Weight Percentage (%) |
|---|---|
| Ferrous lactate | 10 |
| Gum Arabic | 73 |
| Citric acid | 10 |
| Water | 5 |
| Lubricant | 2 |

The extruded ferrous lactate was further coated with a lipid mixture. The composition is shown in Table 5. The lipid blend of coconut oil and stearic acid was fully melted under heat, then fine ascorbic acid was added and mixed uniformly in the molten lipid blend. The mixture was cooled to about 40-45° C. and then extruded ferrous lactate was added to the molten mixture and mixed uniformly. This molten mixture was poured into aluminum foil lined pan which was place in refrigerator for solidification. After fully solidified, the lipid mixture was grinded into smaller flakes. This flaked was added to vegan patty at a dosage of 0.03% ferrous lactate.

TABLE 5

| Material | Weight percentage (%) |
|---|---|
| Extruded ferrous lactate | 10 |
| Coconut oil | 79 |
| Stearic acid | 10 |
| Ascorbic acid | 1 |

No greenish-brown dark spots were observed during mixing and preparation of patty. However, very minor and small dark spots were observed near the fat flakes after 1 day freezing storage followed by 1 day refrigeration storage.

### Example 6: Preparation of Fat Coated Extruded Ferrous Lactate Containing Citric Acid

The extruded ferrous lactate was further coated with a lipid mixture. The composition is shown in Table 6. The lipid blend of coconut oil and stearic acid was fully melted under heat, then fine citric acid was added and mixed uniformly in the molten lipid blend. The mixture was cooled to about 40° C. and then extruded ferrous lactate was added to the molten mixture and mixed uniformly. This molten mixture was poured into aluminum foil lined pan which was place in refrigerator for solidification. After fully solidified, the lipid mixture was grinded into smaller flakes. This flaked was added to vegan patty at a dosage of 0.03% ferrous lactate.

TABLE 6

| Material | Weight percentage (%) |
|---|---|
| Extruded ferrous lactate | 10 |
| Coconut oil | 75 |
| Stearic acid | 10 |
| Citric acid | 5 |

No greenish brown dark spots were observed during mixing and after 1 day freezing storage followed by 1 day refrigeration storage.

### Example 7: Preparation of Mini Burgers and Evaluations

Three raw vegan beef burger patties (Beyond Meat 3.0 vegan burgers purchased from Costco in New Jersey, US) were blended with the prototypes using a 6-quart KitchenAid standard mixer after thawed in the fridge for overnight. Six mini-burgers were made for each prototype by weighing ˜28 g vegan burger which was then placed in a Fisherbrand plastic petri dish and sealed with a piece of wax paper. All the mini-burgers went through one day storage in the freezer and one day storage in the refrigerator. After that, the burgers were taken out and placed in a Hunterlab ColorFlex Spectrophotometer for the color measurement. The instrument was standardized with black-and-white glass plate standards. Each burger sample was analyzed three times and the mean value was recorded as the final colorimetric value for each sample. Values were recorded for the following: L* (lightness), a*(redness), and b*(yellowness). The mean values L̅*̅, a̅*̅, and b̅*̅ were obtained from the six mini-burger samples for each prototype. A total color difference, dE*, was calculated according to the following equation:

$$dE *= \sqrt{{{{( dL \text{*)}}^{2} + ( da \text{*)}}^{2} + ( db \text{*)}}^{2}} = {( L * - {L}_{0} )}^{2} + {( a * - {a}_{0} )}^{2} + {( b * - {b}_{0} )}^{2} ,$$

where L₀, a₀, and b₀ are the color parameters measured for the standard sample (the raw Beyond Meat 3.0 burger without addition of any iron compounds).

### Example 8: The Performance of Different Iron Salts in Vegan Burger Patties

Six food-grade iron salts (ferrous citrate, ferrous lactate, ferric sulfate, ferrous sulfate, ferric citrate, and ferric pyrophosphate) were added separately to vegan burger patties (Beyond Meat 3.0 burgers purchased from Costco in New Jersey, US) at a dosage of 0.003% iron content (calculated from 0.015% Ferrous Lactate) for mini-burger preparation and color measurement (as described in Example 7). The parameters d̅L̅*̅, d̅a̅*̅, and d̅b̅*̅, were determined as the average deviation compared with raw vegan burger without any iron salt. Table 7 shows the results from the colorimetry analysis. Note that the samples using ferric pyrophosphate or ferric citrate showed little discoloration in comparison to the standard vegan burger sample without any iron salts after one day of freezing storage and one day refrigerator storage. By contrast, samples containing ferrous citrate, ferrous lactate, ferric sulfate, and ferrous sulfate all showed significant discoloration of the vegan burger patties. This preliminarily indicates that the use of these salts may be more problematic from a color-retention standpoint than the use of ferric pyrophosphate or ferric citrate in vegan burger applications.

TABLE 7

| Sample | Dosage | d̅L̅ *̅ | d̅a̅ *̅ | d̅b̅ *̅ | d̅E̅ *̅ |
|---|---|---|---|---|---|
| Ferrous Citrate | 0.015% | −3.06 | −6.20 | −2.70 | 7.42 |
| Ferrous Lactate | 0.015% | −3.41 | −5.87 | −2.48 | 7.23 |
| Ferric Sulfate | 0.015% | −2.23 | −5.37 | −3.36 | 6.72 |
| Ferrous Sulfate | 0.009375% | −2.99 | −3.37 | −2.09 | 4.97 |
| Ferric Citrate | 0.015% | 0.19 | −2.75 | −0.83 | 2.88 |
| Ferric Pyrophosphate | 0.01207% | −0.58 | 0.34 | −0.07 | 0.68 |

### Example 9: Preparation of Ferric Citrate with Maltol

Vegan burger samples were prepared using ferric citrate in the same manner as in Example 8, except that maltol was also added to the vegan burger samples at a weight ratio of 3:1 with respect to the concentration of ferric citrate. The vegan burger samples were treated in the same manner as in Example 8 and subjected to the same colorimetric analysis following freezing and refrigerator thawing. The results from the colorimetric analysis are set forth in Table 8. Note that, compared to the vegan burger patty containing ferrous lactate but not maltol (Example 8), the vegan burger patties with ferric citrate and maltol had a much smaller total color difference d̅E̅*̅ from the vegan burger patty without either ferrous lactate or maltol.

TABLE 8

| Sample | d̅L̅ *̅ | d̅a̅ *̅ | d̅b̅ *̅ | d̅E̅ *̅ |
|---|---|---|---|---|
| Ferrous Lactate | −3.41 | −5.87 | −2.48 | 7.23 |
| Ferric Citrate + Maltol | −1.93 | 0.36 | −0.79 | 2.12 |

### Example 10: Preparation of Ferric Citrate with Glutamic Acid and Citric Acid

Vegan burger samples were prepared using ferric citrate in the same manner as in Example 8, except that an amino acid (glutamic acid) and an organic acid (citric acid) were added to the vegan burger samples at a weight ratio of 6.67:1 (each) with respect to the concentration of ferric citrate. The vegan burger samples were treated in the same manner as in Example 8 and subjected to the same colorimetric analysis following freezing and refrigerator thawing. The results from the colorimetric analysis are set forth in Table 9. Note that, according to the color measurement results set forth in Table 9, compared to the vegan burger patty with only ferrous lactate, the vegan burger patties with ferric citrate and stabilizer blend (glutamic acid and citric acid) had smaller total color difference d̅E̅*̅ from the vegan burger patty without any iron salts added.

TABLE 9

| Sample | d̅L̅ *̅ | d̅a̅ *̅ | d̅b̅ *̅ | d̅E̅ *̅ |
|---|---|---|---|---|
| Ferrous Lactate | −3.41 | −5.87 | −2.48 | 7.23 |
| Ferric Citrate + glutamic | 2.56 | −0.57 | −2.43 | 3.57 |
| acid + citric acid | | | | |

### Example 11: Preparation of Ferrous Lactate with the Stabilizer Blend and Iron Blend with the Stabilizer Blend

Two different vegan burger samples were prepared using either ferrous lactate or an iron salt blend (equivalent weights of ferrous lactate, ferrous citrate, ferric citrate) in the same manner as in Example 8, except that two amino acids (glutamic acid and cysteine hydrochloride) and an organic acid (malic acid) were added to the vegan burger samples at a weight ratio of 6.67:1 (each) with respect to the concentration of ferrous lactate or the iron blend. The vegan burger samples were treated in the same manner as in Example 8 and subjected to the same colorimetric analysis following freezing and refrigerator thawing. The results from the colorimetric analysis are set forth in Table 10. Note that, according to the color measurement results set forth in Table 10, compared to the vegan burger patty with only ferrous lactate, the vegan burger patties with iron salt(s) and stabilizer blend (glutamic acid, cysteine hydrochloride, and malic acid) had smaller total color difference d̅E̅*̅ from the vegan burger patty without any iron salts added.

TABLE 10

| Sample | d̅L̅ *̅ | d̅a̅ *̅ | d̅b̅ *̅ | d̅E̅ *̅ |
|---|---|---|---|---|
| Ferrous Lactate | −3.41 | −5.87 | −2.48 | 7.23 |
| Ferrous Lactate with | −0.11 | −4.95 | −1.51 | 5.18 |
| Glutamic acid, | | | | |
| Cysteine•HCl, and Malic | | | | |
| acid | | | | |
| Iron salt blend with | −2.28 | −4.31 | −2.07 | 5.29 |
| Glutamic acid, | | | | |
| Cysteine•HCl, and Malic | | | | |
| acid | | | | |

### Example 12: Preparation of Fat Coated Ferric Citrate with Maltol Using Coconut Oil

A blend of ferric citrate and maltol (1:3 weight ratio) was coated with coconut oil, as described below. The weight ratio of coconut oil to the combined weight of ferric citrate and maltol is 15.67. The coconut oil was fully melted under heat, then the mixture of ferric citrate and maltol was added and mixed uniformly in the molten coconut oil with a Heidolph RZR 2041 lab scale overhead mixer (Heidolph, Schwabach, Germany). The mixture was cooled down in an ice-water bath and then was placed in refrigerator for solidification. After fully solidified, the lipid mixture was ground into smaller flakes. These flakes were added to vegan beef burger patty (Beyond Meat 3.0 purchased from Costco, New Jersey, US) at a normalized dosage of 0.015% ferrous lactate for the mini-burger preparation and color measurement according to the procedure set forth in Example 8. Then, d̅L̅*̅, d̅a̅*̅, and d̅b̅*̅, were determined and the average deviation compared with raw vegan burger without iron salts was calculated. Results are shown in Table 11. Note that, according to the color measurement results in Table 11, compared to the vegan burger patty added with only ferrous lactate, the vegan burger patty with the fat coated ferric citrate with maltol had much smaller total color differences d̅E̅*̅ from the vegan burger patty without any iron salt added.

TABLE 11

| Sample | d̅L̅ *̅ | d̅a̅ *̅ | d̅b̅ *̅ | d̅E̅ *̅ |
|---|---|---|---|---|
| Ferrous Lactate | −3.41 | −5.87 | −2.48 | 7.23 |
| Fat coated Ferric Citrate | 1.94 | −0.05 | −2.26 | 2.98 |
| and Maltol | | | | |

### Example 13: Preparation of Fat Coated Ferrous Lactate-Amino Acid/Organic Acid Mix Using Coconut Oil

Two blends of ferrous lactate with one of two blends of amino/organic acids (a 1:1:1 by weight blend of glutamic acid, cysteine hydrochloride, and malic acid, or a 1:1:1 by weight blend of aspartic acid, proline, and citric acid) were coated with coconut oil. The weight ratio of the amino/organic acid blend to the ferrous lactate in each blend was 20:1. The weight ratio of the coconut oil to the iron salt and the amino/organic acids combined is 2.17. The coconut oil was fully melted under heat, then the mixture of ferrous lactate and amino/organic acid mix was added and mixed uniformly in the molten coconut oil with a Heidolph RZR 2041 lab scale overhead mixer (Heidolph, Schwabach, Germany). The mixture was cooled in an ice-water bath and then was placed in a refrigerator for solidification. After fully solidified, the lipid mixture was ground into smaller flakes. These flakes were added to a vegan beef burger patty (Beyond Meat 3.0 purchased from Costco, New Jersey, US) at a dosage of 0.015% ferrous lactate for the mini-burger preparation and color measurement according to the procedure set forth in Example 8. Then, d̅L̅*̅, d̅a̅*̅, and d̅b̅*̅, were determined and the average deviation was calculated and compared with raw vegan burger without any iron salt added. The results are shown in Table 12. Note that, according to the color measurement results in Table 12, compared to the vegan burger patty added with only ferrous lactate, the two vegan burger patties with the fat-coated ferrous lactate and amino/organic acid mix had much smaller total color differences d̅E̅*̅ from the vegan burger patty without ferrous lactate.

TABLE 12

| Sample | d̅L̅ *̅ | d̅a̅ *̅ | d̅b̅ *̅ | d̅E̅ *̅ |
|---|---|---|---|---|
| Ferrous Lactate | −3.41 | −5.87 | −2.48 | 7.23 |
| Fat-coated Ferrous | −1.85 | −1.65 | −2.21 | 3.32 |
| Lactate with Glutamic | | | | |
| acid, Cysteine•HCl, and | | | | |
| Malic acid | | | | |
| Fat-coated Ferrous | −1.83 | −1.95 | −1.55 | 3.09 |
| Lactate with Aspartic | | | | |
| acid, Proline, and Citric | | | | |
| acid | | | | |

### Example 14: Preparation of Fat Coated Ferrous Lactate-Amino Acid/Organic Acid Mix Using Coconut Oil Combined with Stearic Acid

A blend of ferrous lactate with an amino/organic acid mixture (a 1:1:1 by weight blend of aspartic acid, proline, and citric acid) was coated with a lipid blend of coconut oil and stearic acid (5.85:1 w/w ratio). The weight ratio of the amino/organic acid blend to the ferrous lactate in the blend was 20:1. The weight ratio of the coconut oil and stearic acid blend to the iron salt and the amino/organic acids combined was 2.17. The coconut oil and stearic acid were fully melted under heat, then the mixture of ferrous lactate and amino/organic acid mix was added and mixed uniformly in the molten fat blend with a Heidolph RZR 2041 lab scale overhead mixer (Heidolph, Schwabach, Germany). The mixture was cooled in an ice-water bath and then was placed in refrigerator for solidification. After fully solidified, the lipid mixture was ground into smaller flakes. These flakes were added to a vegan beef burger patty (Beyond Meat 3.0 purchased from Costco, New Jersey, US) at a dosage of 0.015% ferrous lactate for the mini-burger preparation and color measurement according to the procedure set forth in Example 8. Then, d̅L̅*̅, d̅a̅*̅, and d̅b̅*̅, were determined and the average deviation was calculated and compared with raw vegan burger without ferrous lactate. The results are shown in Table 13. Note that, according to the color measurement results in Table 13, compared to the vegan burger patty with only ferrous lactate, the vegan burger patty with the fat-coated ferrous lactate and amino/organic acid mix had smaller total color difference d̅E̅*̅ from the vegan burger patty without ferrous lactate.

TABLE 13

| Sample | d̅L̅ *̅ | d̅a̅ *̅ | d̅b̅ *̅ | d̅E̅ *̅ |
|---|---|---|---|---|
| Ferrous Lactate | −3.41 | −5.87 | −2.48 | 7.23 |
| Fat-coated Ferrous | 0.61 | −1.76 | −4.89 | 5.24 |
| Lactate with Aspartic | | | | |
| acid, Proline, and Citric | | | | |
| acid) | | | | |

1-10. (canceled)

11. A comestible composition comprising a non-animal protein and one or more comestible particles,
wherein each of the one or more comestible particles comprises a lipid-based encapsulant that comprises an encapsulated material,
wherein the lipid-based encapsulant comprises a lipid component, and
wherein the encapsulated material comprises a metal compound.

12. The comestible composition of claim 11, wherein the non-animal protein is a plant protein.

13. The comestible composition of claim 11, wherein the comestible composition further comprises a plant fiber.

14. A flavored product, which comprises a comestible composition of claim 11.

15. The flavored product of claim 14, wherein the flavored product is a ground beef replica.

16. The comestible composition of claim 11, wherein the lipid component comprises a non-animal fat, a non-animal free fatty acid, or any combination thereof.

17. The comestible composition of claim 11, wherein the metal compound is an iron compound.

18. The comestible composition of claim 17, wherein the metal compound is an iron salt.

19. The comestible composition of claim 18, wherein the iron salt is ferrous lactate, ferrous sulfate, ferrous citrate, ferric citrate, ferric phosphate, or any combinations thereof.

20. The comestible composition of claim 11, wherein the encapsulated material comprises an organic acid.

21. The comestible composition of claim 20, wherein the organic acid is propionic acid, butyric acid, caproic acid, caprylic acid, succinic acid, cysteine (or hydrochloride salts thereof), lysine (or hydrochloric salts thereof), glutamic acid, aspartic acid, glutaric acid, thiamine (or hydrochloride salts thereof), pyrrolidone carboxylic acid, arachidonic acid, lactic acid, acetic acid, citric acid, ascorbic acid, oxalic acid, tartaric acid, malonic acid, malic acid, or any combination thereof.

22. The comestible composition of claim 11, wherein the one or more comestible particles each comprises a chelating agent.
